(19) United States
(12) Patent Application Publication
(10) Pub. No.: US 2009/0290005 A1
(43) Pub. Date: Nov. 26, 2009

(54) Liquid Container, and Method for Manufacturing the Same

(75) Inventors: Akihisa WANIBE, Matsumoto-shi (JP); Masaki SATO, Matsumoto-shi (JP); Kazunobu MARUYAMA, Matsumoto-shi (JP); Takayuki AYUZAWA, Okaya-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/472,164

(22) Filed: May 26, 2009

(30) Foreign Application Priority Data
May 26, 2008 (JP) 2008-136221

(51) Int. Cl. B41J 2/175; B23P 11/00

(52) U.S. Cl. 347/86; 29/505

(57) ABSTRACT

A liquid container includes a container body having a fluid channel forming portion for forming a fluid channel in which a liquid flows, a sensor member having a sensor and a film that is adapted to fix the sensor member to the container body. The fluid channel forming portion has a container side opening section opened so as to face the sensor member and an outer peripheral portion disposed so as to surround the container side opening section, the film is adapted to seal a portion between an outer edge portion of the sensor member and the outer peripheral portion of the fluid channel forming portion, and the outer peripheral portion has an elastically deformable portion that allows the sensor member to move in a direction away from the container side opening section.

### BACKGROUND

1. Technical Field

The present invention particularly relates to a liquid container and a method for manufacturing the same, and particularly relates to a liquid container having a sensor for detecting a liquid and a method for manufacturing the same.

2. Related Art

A liquid container containing a liquid is used in a liquid ejecting apparatus such as an ink jet printer in order to supply a liquid to be ejected to the liquid ejecting apparatus.

As existing methods for managing a residual amount of a liquid in a liquid container, a method for managing a residual amount of a liquid by allowing a liquid ejecting apparatus to add up values of the amounts of liquid ejected therefrom by using software or a method for managing a liquid by providing a liquid residual amount sensor to a liquid container are known. As the latter case, JP-A-2001-146030 which is an example of the related art, discloses a residual liquid sensor including a piezoelectric element. The sensor is adapted to judge a residual amount of a liquid in a liquid container by using a principle that a resonant frequency of a residual oscillation signal due to a residual vibration (free vibration) of a diaphragm having laminated piezoelectric elements after forced vibration varies depending on whether a liquid resides in a cavity which faces the diaphragm or does not reside in the cavity. JP-A-2006-281550 is also an example of the related art.

However, a sensor having a piezoelectric element may be possibly damaged by pressure variation in a liquid in a cavity. As a cause of the pressure variation, freezing of a liquid or an increase of the volume the liquid due to temperature change can be listed. The above problem exists not only for a liquid container having a sensor including a piezoelectric element, but commonly arises in any liquid container having such a sensor.

### SUMMARY

An advantage of some aspects of the invention is that it prevents a sensor from being damaged in a liquid container having the sensor. In order to solve at least a part of the above problems, the invention is achieved by embodiments or adaptations described below.

A liquid container according to a first aspect of the invention includes a container body having a fluid channel forming portion forming a fluid channel for a liquid flowing therein, a sensor member having a sensor, and a film for fixing the sensor member to the container body. The fluid channel forming portion includes a container side opening section opened so as to face the sensor member and an outer peripheral portion disposed so as to surround the container side opening section. The film is adapted to seal a portion between an outer edge portion of the sensor member and the outer peripheral portion of the fluid channel forming portion, and the outer peripheral portion has an elastically deformable portion that allows the sensor member to move in a direction away from the container side opening section. With this configuration, it is possible to prevent a pressure of ink in the fluid channel from being increased, thereby avoiding damage to the sensor.

In the liquid container according to the first aspect of the invention, the elastically deformable portion preferably includes a thin shaped portion to which the film is stuck. With this configuration, it is possible to facilitate the elastic deformation.

In the liquid container according to the first aspect of the invention, a gap is preferably formed between the thin shaped portion and an upper wall face of the container side opening section. With this configuration, it is possible to form the thin shaped portion of the outer peripheral portion as an elastically deformable portion.

In the liquid container according to the first aspect of the invention, the film is preferably adhered to the outer peripheral portion by thermal welding, and a height of an inner side of the outer peripheral portion is lower than a height of an outer side of the outer peripheral portion at the upper wall face of the container side opening section. With this configuration, it is possible to readily form a gap between the thin shaped portion and the upper wall face.

In the liquid container according to the first aspect of the invention, the sensor member is preferably a plate member having a first face and a second face opposite the first face. The sensor member includes a base member having first and second through-holes passing through from the first face to the second face and the outer edge portion surrounding the first and second through-holes, and a sensor chip that includes formed therein a cavity having a bottom and an opening section capable of receiving a liquid, and is provided with the sensor disposed at a rear side of the bottom of the cavity. The sensor chip is disposed on the first face of the base member so as to allow the opening section of the cavity to communicate with the first and second through-holes. With this configuration, it is possible to prevent damage to the sensor which may be caused by increase of an ink pressure in the cavity.

In the liquid container according to the first aspect of the invention, the container side opening section is preferably a base member housing section for accommodating the second face side of the base member. The base member housing section has a partition wall that abuts the second face of the base member and is caused by the abutment to divide the fluid channel into a first fluid channel communicating with the first through-hole of the base member and a second fluid channel communicating with the second through-hole of the base member. With this configuration, the upstream side fluid channel and the downstream side fluid channel are formed by the base member housing section.

In the liquid container according to the first aspect of the invention, the sensor is preferably adapted to detect information about the liquid via vibration of a piezoelectric element. The base member and the base member housing section are not in contact with each other excluding portions corresponding to a positioning portion of the base member with respect to the base member housing section and an abutment portion with respect to an end portion of the partition wall. With this configuration, it is possible to prevent the vibration of the piezoelectric element from being absorbed and attenuated by the container body. Accordingly, detection accuracy of the sensor can be improved.

In the liquid container according to the first aspect of the invention, the sensor preferably includes a piezoelectric element. With this configuration, it is possible to suppress damage to the piezoelectric element.

A method for manufacturing a liquid container according to a second aspect of the invention, uses a container body having channel forming section for forming a liquid channel allowing a liquid to flow therein, a sensor member having a sensor, and a film for fixing the sensor member to the container body. The channel forming section has a container side opening section opened so as to face the sensor member, a rib disposed so as to surround the opening section and an upper wall face of the container side opening section having a height at an inner side of the rib lower than that of an outer side of the rib. The method for manufacturing the liquid container includes steps of (a) fixing the film to an outer edge portion of the sensor member, (b) positioning the sensor member to the container side opening section, and (c) adhering the film to the rib and crushing the rib. With this configuration, it is possible to form a gap between the thin shaped portion formed by the crushed rib and the upper wall face. As a result, the thin shaped portion having the film adhered thereto can be elastically deformable so as to allow the sensor member to move in a direction away from the container side opening section. Therefore, it is possible to produce an ink cartridge capable of suppressing increase of the ink pressure, thereby preventing damage to the sensor.

The method for manufacturing the liquid container according to the second aspect of the invention, in the step (c), the film is preferably thermally welded to the rib. With this configuration, it is possible to concurrently carry out the adhering of the rib to the film and the crushing of the rib.

The invention can be realized in various forms such as a liquid detecting device or a liquid ejecting system. In addition, the invention can be realized in the form of a manufacturing device of the liquid container.

### BRIEF DESCRIPTION OF THE DRAWINGS

The invention will be described with reference to the accompanying drawings, wherein like numbers reference like elements.

FIG. 1 is a schematic view showing a structure of a printing system of an embodiment of the invention.

FIG. 2 is a schematic, exploded, perspective view showing a structure of an ink cartridge.

FIG. 3 is an enlarged, exploded, perspective view showing the ink cartridge at a front face side.

FIG. 4 is a schematic view showing a structure of a sensor base member.

FIG. 5 is a first schematic view showing structures of the sensor base member and a sensor chip.

FIG. 6 is a second schematic view showing the structures of the sensor base member and the sensor chip.

FIG. 7 is a first schematic view showing a structure of a container body at a portion around a base member housing section.

FIG. 8 is a second schematic view showing the structure of the container body at the portion around the base member housing section.

FIGS. 9A and 9B are enlarged views showing a portion IX in FIG. 8.

FIG. 10 is a flowchart showing operation of a method for manufacturing the ink cartridge in the embodiment.

FIG. 11 is a first schematic view showing the ink cartridge for explanation of its production.

FIG. 12 is a second schematic view showing the ink cartridge for explanation of its production.

FIGS. 13A and 13B are schematic views showing a structure of a portion around the welding rib 132 before and after the welding is carried out, respectively.

### DESCRIPTION OF EXEMPLARY EMBODIMENTS

### A. Embodiment: Structure of Printing System

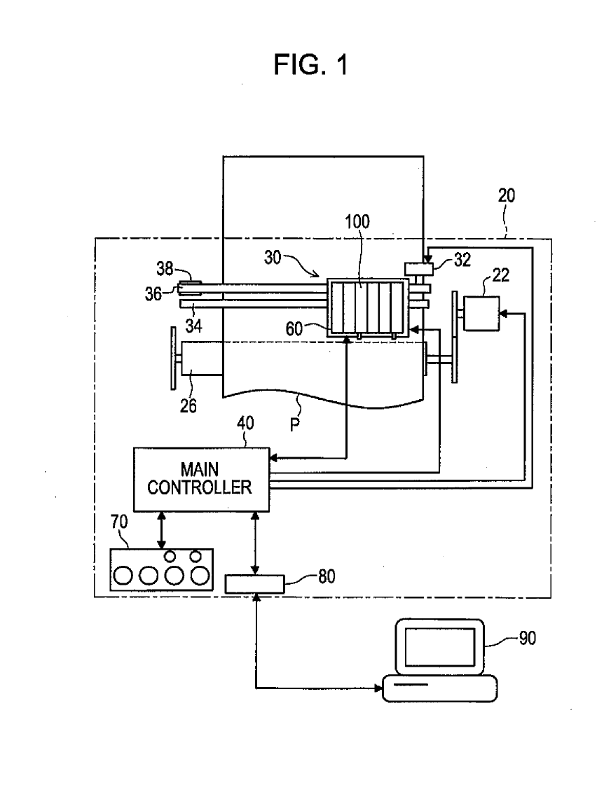

A preferred embodiment of the invention is described below. FIG. 1 is a schematic view showing a structure of a printing system. The printing system includes a printer 20, a computer 90, and an ink cartridge 100. The printer 20 is coupled to the computer 90 via a connector 80.

The printer 20 is equipped with a sub-scanning transporting mechanism, a main scanning transporting mechanism, a head driving mechanism and a main controller 40 for controlling the mechanisms. The sub-scanning transporting mechanism is equipped with a paper feed motor 22 and a platen 26, and transports a paper sheet P in the sub-scanning direction by transmitting rotation of the paper feed motor 22 to the platen 26. The main scanning transporting mechanism is equipped with a carriage motor 32, a pulley 38, a driving belt 36 suspended between the carriage motor 32 and the pulley 38, and a sliding shaft 34 provided parallel to a shaft of the platen 26. The sliding shaft 34 slidably holds the carriage 30 fixed to the driving belt 36. The rotation of the carriage motor 32 is transmitted to the carriage 30 via the driving belt 36, and the carriage 30 is reciprocated in an axial direction (main scanning direction) of the platen 26 along the sliding shaft 34. The head driving mechanism has a print head unit 60 mounted on the carriage 30 and causes the print head unit 60 to eject ink on a paper sheet P by driving the print head unit 60. A plurality of ink cartridges can be detachably attached to the print head unit 60 as described later. The printer 20 is further equipped with an operational section 70 allowing a user to perform various kinds of setting operations of the printer 20 and to confirm status of the printer 20.

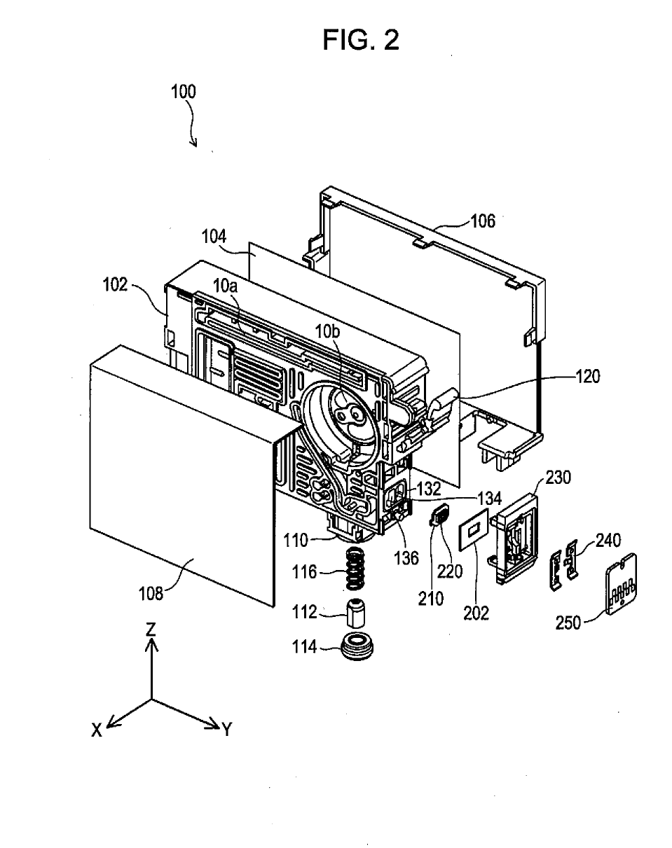

FIG. 2 is a schematic exploded perspective view showing a structure of an ink cartridge 100. A vertical direction under a condition that the ink cartridge 100 is attached to the carriage 30 is coincident with a direction of a Z axis in FIG. 2.

The ink cartridge 100 has a container body 102, a first film 104, a second film 108 and a lid body 106. These members are, for example, made of resins capable of being welded with each other. A liquid supply section 110 is formed on a lower face of the container body 102. In the liquid supply section 110, a seal member 114, a spring washer 112 and a stoppage spring 116 are accommodated in this order from the lower face side. The seal member 114 is adapted to seal a portion between an inner wall of the liquid supply section 110 and an outer wall of an ink receiving needle (not shown) of the print head unit 60 so that a gap is not formed therebetween while the ink receiving needle is inserted into the liquid supply section 110. The spring washer 112 is adapted to close the liquid supply section 110 by being in contact with an inner wall of the seal member 114 while the ink cartridge 100 is not attached to the print head unit 60. The stoppage spring 116 urges the spring washer 112 in a direction to bring the spring washer 112 into contact with the inner wall of the seal member 114. When the ink supply needle is inserted into the liquid supply section 110, an upper end of the ink supply needle pushes the spring washer 112 up. As a result, a gap is formed between the spring washer 112 and the seal member 114 so that the ink can be supplied to the ink supply needle via the gap.

Fluid channel forming portions having various shapes such as a rib 10a are formed on a front face (a face at an X axis forward direction side), a rear face (a face at an X axis backward direction side) and a front side face (a face at a Y axis forward direction side) of the container body 102. The first film 104 and the second film 108 are stuck to the container body 102 so as to entirely cover the respective front and rear faces. The first film 104 and the second film 108 are precisely stuck so that a gap is not formed between the films and the end faces of the fluid channel forming portions formed on the container body 102. The fluid channels such as a plurality of small chambers or narrow fluid channels are partitioned and formed in the ink cartridge 100 by the liquid forming portions, the first film 104 and the second film 108. A negative pressure generating valve is disposed between a valve housing section 10b and the second film 108, the valve housing section 10b being formed in the container body 102 as a part of the fluid channel forming portions. In order to avoid complicating the drawing, the negative pressure generating valve is not shown. The lid body 106 is attached to the rear face side of the container body 102 so as to cover the first film 104.

One end of the fluid channel formed in the ink cartridge 100 communicates with an atmospheric air and the other end communicates with the liquid supply section 110. Namely, the ink cartridge 100 is atmospheric air communicating type cartridge in which the atmospheric air is introduced into the fluid channel as the ink is supplied to the printer 20. Detailed explanation of the structure of the fluid channel is omitted.

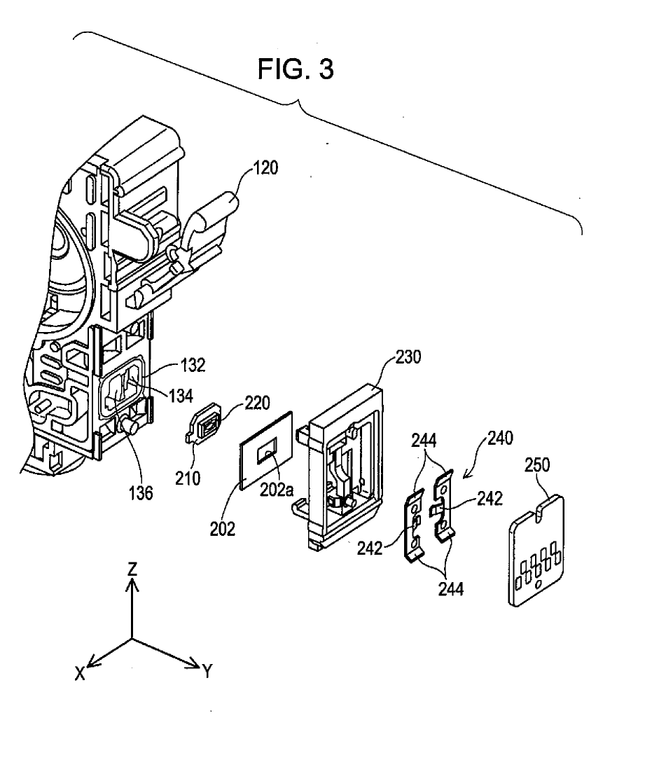

FIG. 3 is an enlarged, exploded, perspective view showing the ink cartridge 100 at the front side face. A lever 120 to be engaged with a holder provided to the print head unit 60 is provided to the container body 102 at the front side face. For example, a base member housing section 134 as a part of the fluid channel forming portions is opened at a lower position of the lever 120. A welding rib 132 is formed at a portion around the opening section of the base member housing section 134. A partition wall 136 for partitioning the fluid channel formed by the base member housing section 134 into an upstream side fluid channel and a downstream side fluid channel is formed in the base member housing section 134.

A sensor base member 210, a sensor chip 220, a welding film 202, a cover 230, a relay terminal 240 and a circuit board 250 are attached in this order to a portion in the vicinity of the base member housing section 134 of the container body 102.

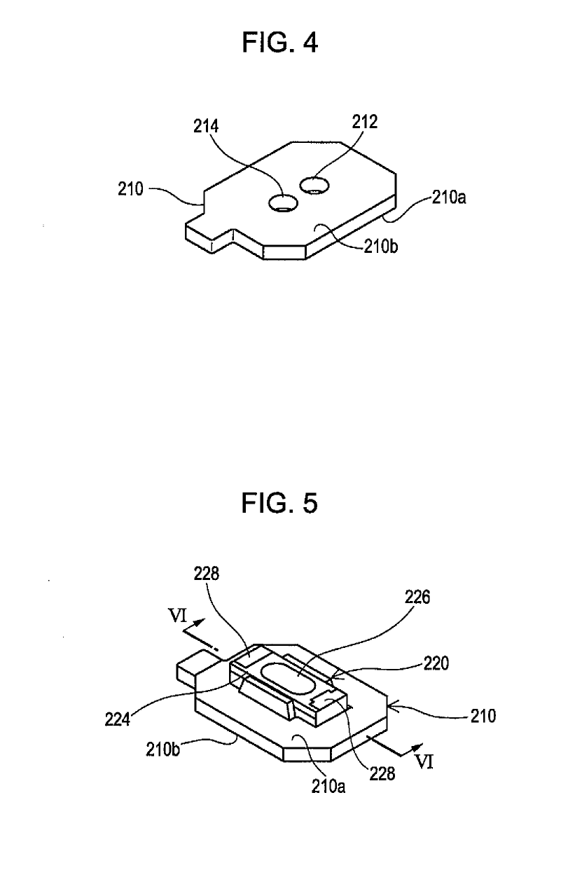

FIG. 4 is a schematic view showing a structure of the sensor base member 210. The sensor base member 210 is a plate member made of metal such as SUS (stainless). The sensor base member 210 has a second face 210b as a face to be accommodated in the base member housing section 134 and a first face 210a as a face opposing the second face 210b. First and second through-holes 212 and 214 passing through the first face 210a to the second face 210b are formed in a portion around the center of the sensor base member 210.

FIG. 5 is a first schematic view showing the structures of the sensor base member 210 and the sensor chip 220. The sensor chip 220 is bonded to the first face 210a of the sensor base member 210 so as to cover the first and second through-holes 212 and 214. A piezoelectric element 226, a diaphragm 224 and two electrode terminals 228 are arranged on the sensor chip 220. The structure of the sensor chip 220 is described later.

Returning to FIG. 3, the welding film 202 is adapted to hold the sensor base member 210 at the opening section of the base member housing section 134 and precisely seal the base member housing section 134 as the fluid channel. The welding film 202 is bonded to an outer peripheral portion of the first face 210a of the sensor base member 210 and welded to the welding rib 132. The cover 230 is disposed so as to protect the sensor chip 220 and the welding film 202. The relay terminal 240 is accommodated in the cover 230. The relay terminal 240 is equipped with a terminal 242 which is electrically connected to the electrode terminal 228 of the sensor chip 220 via a hole 202a formed on the welding film 202. The circuit board 250 is attached to the cover 230 and is electrically connected to a terminal 244 of the relay terminal 240.

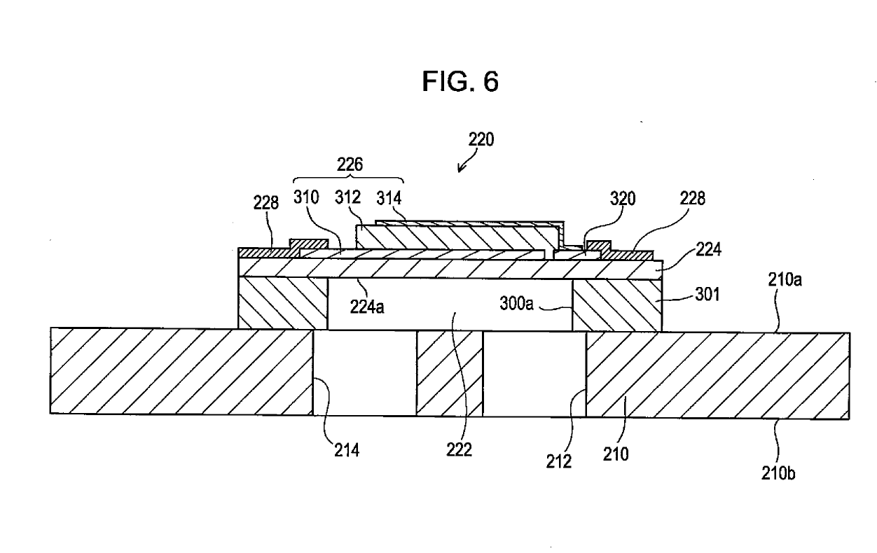

FIG. 6 is a second schematic view showing the structure of the sensor base member 210 and the sensor chip 220. FIG. 6 is a cross sectional view that corresponds to a cross section taken along VI-VI line in FIG. 5.

The sensor chip 220 has a sensor cavity 222 for receiving ink to be detected. A lower side of the sensor cavity 222 in FIG. 6 is opened so as to receive the ink. A bottom (upper side in FIG. 6) of the sensor cavity 222 is constituted of the diaphragm 224. To be specific, the sensor chip 220 has a cavity plate 301 having a through-hole 300a and the diaphragm 224. The cavity 222 is formed of an inner wall face of the through-hole 300a and a face 224a (also referred to as a lower face) at a cavity plate 301 side of the diaphragm 224. One end of the sensor cavity 222 communicates with the first through-hole 212 and the other end communicates with the second through-hole 214. As a result, the sensor cavity 222 and the first and second through-holes 212 and 214 form an ink channel (also referred to as a sensor fluid channel) having a U-shaped cross section.

The piezoelectric element 226, the two electrode terminals 228 and an auxiliary electrode 320 are arranged on a face (also referred to as an upper face) of the diaphragm 224 at the opposite side of the cavity plate 301. The piezoelectric element 226 is disposed at a position facing the sensor cavity 222 with the diaphragm 224 therebetween. The two electrode terminals 228 are respectively arranged at both sides of the piezoelectric element 226. The piezoelectric element 226 includes a lower electrode 310, a piezoelectric layer 312 and an upper electrode 314. The lower electrode 310 is disposed on the upper face of the diaphragm 224. The piezoelectric layer 312 is provided on the lower electrode 310. The upper electrode 314 is provided on the piezoelectric layer 312.

The lower electrode 310 is electrically connected to one of the electrode terminals 228. The upper electrode 314 is connected to the auxiliary electrode 320. The auxiliary electrode 320 is connected to the other electrode terminal 228. The auxiliary electrode 320 is isolated from the lower electrode 310.

The piezoelectric element 226 basically has a function of judging an out-of-ink state in accordance with an electric characteristic (e.g., frequency) that differs depending on the presence or absence of the ink in the sensor cavity 222. As a material of the piezoelectric layer, lead zirconate titanate (PZT), lead lanthanum zirconate titanate (PLZT) or a lead-free piezoelectric film can be used.

The sensor chip 220 is integrally fixed to the sensor base member 210 such that the lower face of the cavity plate 301 is stuck to the upper face of the sensor base member 210 at the central part by an adhesive. By the adhering, a portion between the sensor base member 210 and the sensor chip 220 is sealed.

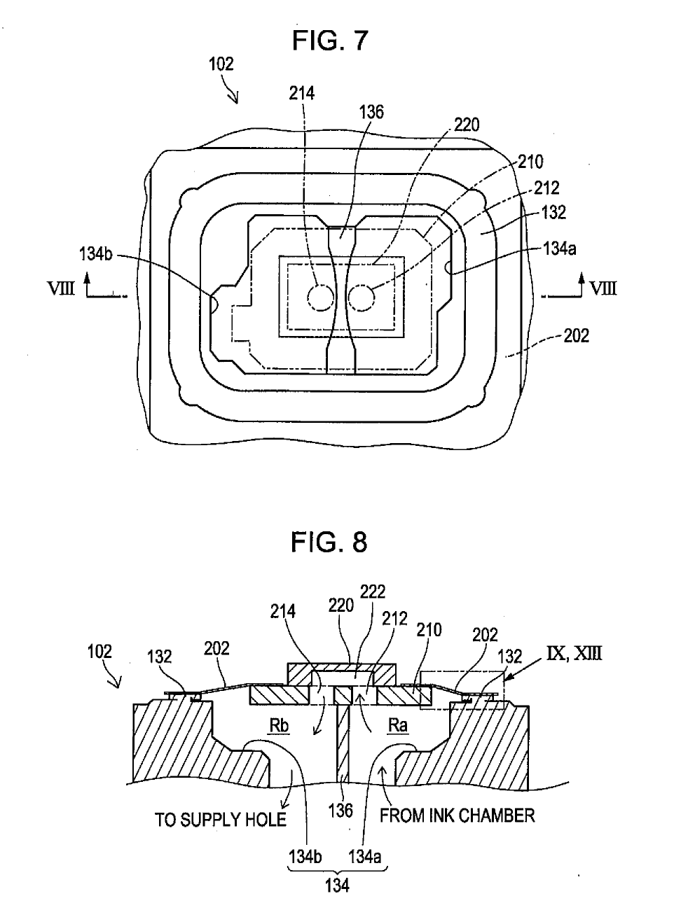

FIG. 7 is a first schematic view showing the structure of the container body 102 at a portion around the base member housing section 134. FIG. 8 is a second schematic view showing the structure of the container body 102 at the portion around the base member housing section 134. FIG. 8 is a cross sectional view that corresponds to a cross section taken along VIII-VIII line in FIG. 7. The partition wall 136 is disposed at the base member housing section 134. In FIG. 7, to avoid complication, only contours of the sensor chip 220 and the sensor base member 210 are indicated by chain double-dashed lines, and welding film 202 is indicated by a dashed line.

An inner peripheral edge portion of the welding film 202 is bonded to an outer peripheral edge portion of the first face 210a of the sensor base member 210, as described above. An outer peripheral edge portion of the welding film 202 is welded to the welding rib 132. As a result, the second face 210b of the sensor base member 210 abuts the end face of the partition wall 136 at an abutment portion. The end face of the partition wall 136 abuts a portion between the first through-hole 212 and the second through-hole 214 on the second face 210b. Accordingly, the base member housing section 134 is divided into an upstream side channel forming portion 134a and a downstream side channel forming portion 134b. The upstream side channel forming portion 134a demarcates an upstream side channel Ra communicating with the sensor fluid channel at the upstream side (at a first through-hole 212 side) together with the welding film 202 and the second face 210b of the sensor base member 210. The downstream side channel forming portion 134b demarcates a downstream side channel Rb communicating with the sensor fluid channel at the downstream side (at a second through-hole 214 side) together with the welding film 202 and the second face 210b of the sensor base member 210.

Here, the sensor base member 210 is not in contact with the container body 102 excluding the end portion of the partition wall 136 and a positioning portion with respect to the base member housing section 134. Thus, a contact area between the sensor member 210 and the container body 102 is reduced so that it is possible to prevent vibration of the piezoelectric element 226 of the sensor chip 220 from being attenuated by being absorbed by the container body 102. With this configuration, it is possible to improve detection accuracy of the out-of-ink state.

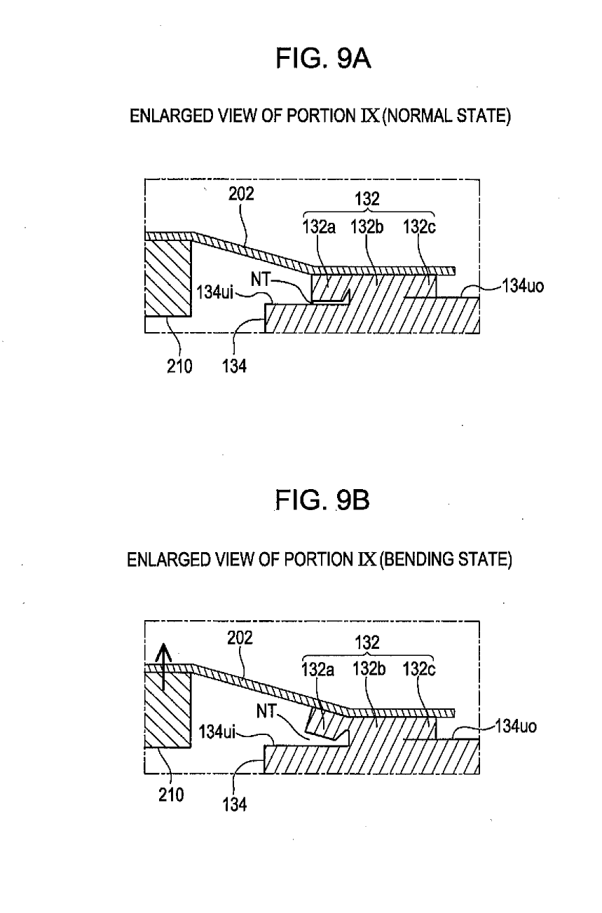

FIGS. 9A and 9B are enlarged views of a portion IX in FIG. 8. The welding rib 132 is changed so as to be in a thin shape when being welded and to have a base portion 132b, an inner melted-out portion 132a and an outer melted-out portion 132c. The welding film 202 is welded to the entirety of the upper face of the welding rib 132. In the embodiment, a slight gap NT is formed between an upper face portion 134ui of the base member housing section 134 and the inner melted-out portion 132a. As a result, the upper face portion 134ui of the base member housing section 134 and the inner melted-out portion 132a are overlapped with each other in the thickness direction of the welding film 202, but are not welded to each other.

With the above configuration, the sensor base member 210 can move in a direction away from the base member housing section 134 (container body 102) as shown in FIG. 9B by an arrow. This is because the inner melted-out portion 132a can be bent so as to widen the gap NT as shown in FIG. 9B. As a result, when the volume of the ink is increased, the increasing of the ink pressure due to the increase of the volume can be suppressed. Namely, This is because the sensor member 210 moves in the direction away from the base member housing section 134 (container body 102) so that a volume equivalent to the amount of increased volume of the ink can be absorbed. Accordingly, it is possible to prevent damage to the thin diaphragm 224 or the piezoelectric element 226 due to the increase of the ink pressure.

Method for Detecting Out-of-Ink State

As shown in FIG. 8, the ink introduced in the upstream side channel Ra is introduced to the sensor cavity 222 of the sensor chip 220 via the first through-hole 212. The vibration of the diaphragm 224 vibrated by the piezoelectric element 226 is transmitted to the ink. The presence or absence of the ink can be detected on the basis of the frequency of the residual oscillation waveform. In an out-of-ink point where, rather than the ink, air is input to the sensor cavity 222, an attenuation degree of the residual oscillation waveform is increased so that the frequency is increased as compared to that in a case where the sensor cavity is fully filled with the ink. By detecting the above change of the frequency, the out-of-ink state can be detected.

To be specific, when a driving voltage is applied to the piezoelectric element 226 from the printer 20 via the circuit board 250, the diaphragm 224 is deformed in conjunction with the deformation of the piezoelectric element 226. When the application of the drive voltage is stopped after the piezoelectric element 226 is unconditionally deformed, the diaphragm 224 continues to undergo bending vibration for a while. The residual vibration is free vibration between the diaphragm 224 and a medium in the sensor cavity 222. Therefore, by making the driving voltage to be applied to the piezoelectric element 226 be, for example, in a pulse waveform or a rectangular waveform, it is possible to readily generate a resonant condition between the diaphragm 224 and the medium after applying the driving voltage to the piezoelectric element 226.

The residual vibration that is generated in the diaphragm 224 induces deformation of the piezoelectric element 226. As a result, the piezoelectric element 226 generates a back electromotive force in conjunction with the residual vibration. The printer 20 can acquire a response signal corresponding to the back electromotive force via the circuit board 250. The main controller 40 of the printer 20 can detect the presence or absence of the ink in the ink cartridge 100 by measuring the frequency of the response signal.

Method for Manufacturing Ink Cartridge 100

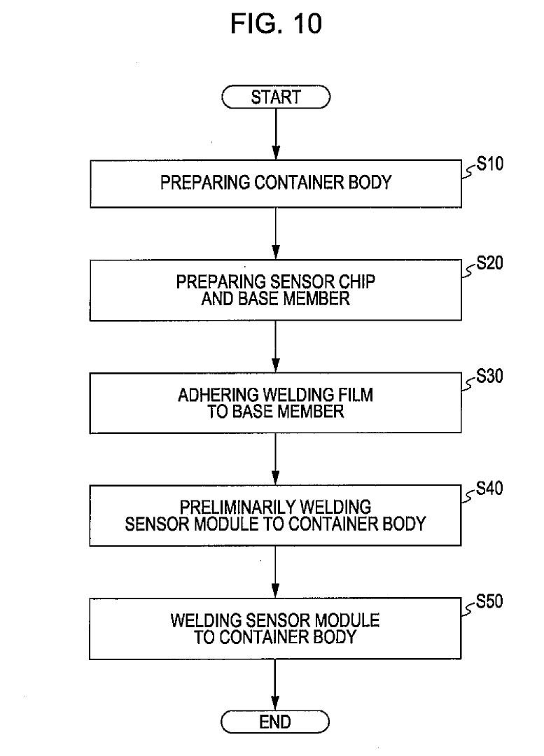

FIG. 10 is a flowchart showing operation of a method for manufacturing an ink cartridge 100 in the embodiment. In the flowchart, operation excluding a process of mounting the sensor base member 210 and the sensor chip 220 to the base member housing section 134 by using the welding film 202 are omitted.

In step S10, the container body 102 is prepared. The container body 102 is made by a well known resin forming technique such as injection molding, pressure molding or cutting processing.

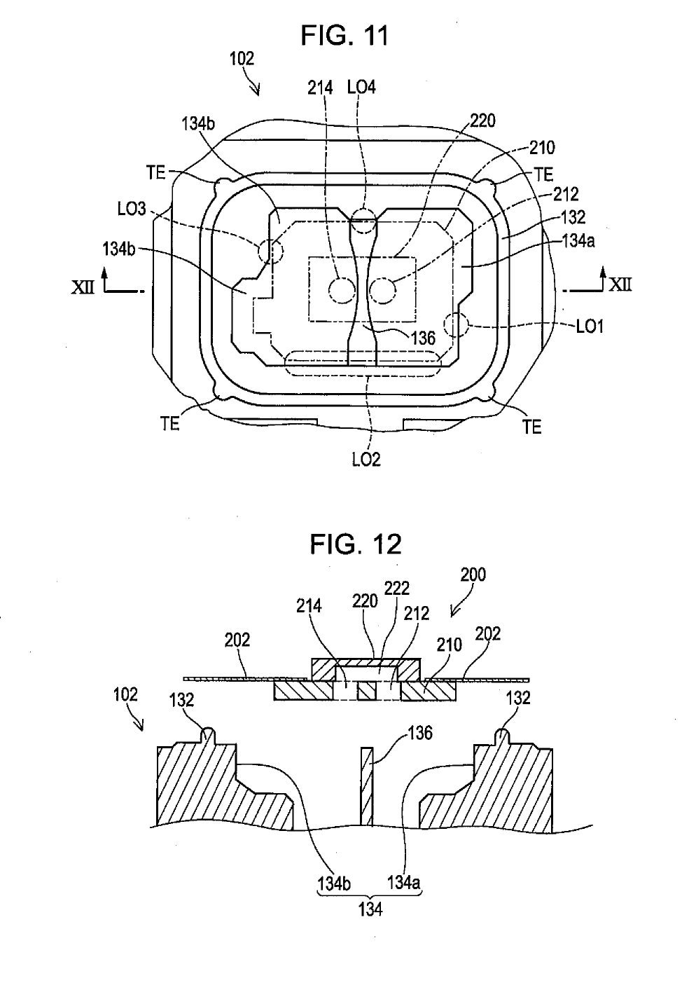

FIG. 11 is a first schematic view showing the ink cartridge 100 for explanation of production of the ink cartridge 100. FIG. 12 is a second schematic view showing the ink cartridge 100 for explanation of production of the ink cartridge 100. FIG. 11 shows a structure of the prepared container body 102 around the base member housing section 134. Needless to say, the prepared container body 102 has the welding rib 132 which has not yet been welded.

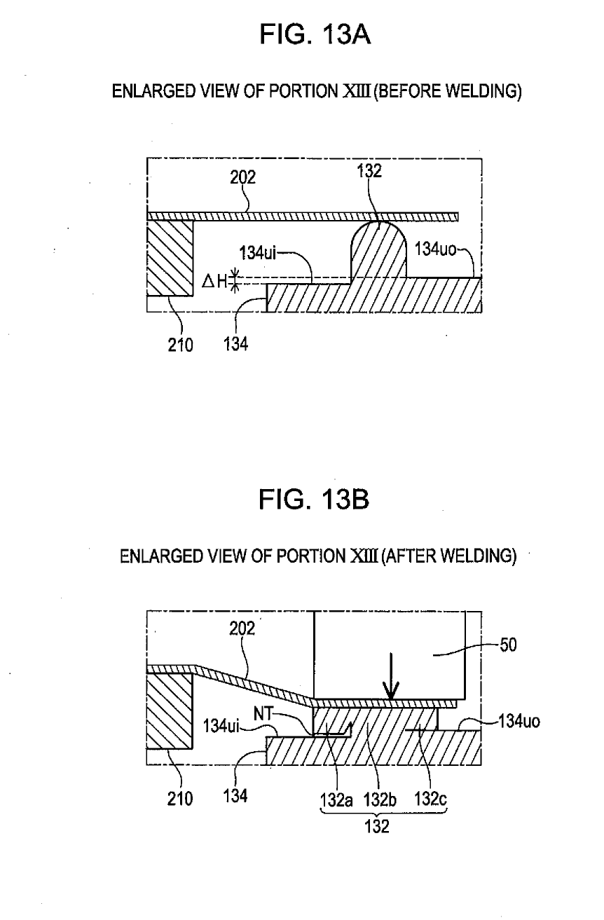

FIGS. 13A and 13B are schematic views showing the structure around the welding rib 132 before and after the welding is carried out, respectively. The container 102, in the upper face at the periphery of the base member housing section 134, is designed so that a portion 134ui inside the welding rib 132 (hereinafter referred to as an inner side upper face) is made to be lower than a portion 134uo outside the welding rib 132 (hereinafter referred to as an outer side upper face) by a value of ΔH. The value of ΔH is, for example, may be set in a range of approximately 0.05 to 0.2 mm.

In step S20, the sensor base member 210 and the sensor chip 220 are prepared. The sensor base member 210 and the sensor chip 220 are bonded with each other beforehand as described above.

In step S30, the welding film 202 is bonded to the outer peripheral portion of the first face 210a of the sensor base member 210. Here, a module having the sensor member 210, the sensor chip 220 and the welding film 202 which are united with each other is referred to as a sensor module 200 (see FIG. 12).

In step S40, the sensor module 200 is preliminarily welded to the container body 102. In the preliminarily welding, the sensor module 200 is positioned relative to the container body 102, and the welding film 202 of the sensor module 200 is welded to preliminary welding portions TE (see FIG. 11) disposed at four corners of the welding rib 132. The positioning is carried out such that the sensor base member 210 of the sensor module 200 at the second face 210b side is accommodated in the base member housing section 134 and the second face 210b is brought into contact with the end portion of the partition wall 136 at the abutment portion. In FIG. 11, a portion indicated by a chain double-dashed line is an ideal positioning area of the sensor module 200. Four positioning portions LO1 to LO4 are indicated on an inner wall of the base member housing section 134 by dashed lines. There is a possibility that the sensor base member 210 is brought into contact with the container body 102 at a part of the four positioning portions LO1 to LO4. However, the sensor base member 210 and the container body 102 are not in contact with each other excluding portions corresponding to the positioning portions LO1 to LO3 and the end portion of the partition wall 136.

In step S50, the sensor module 200 is welded to the container body 102. To be specific, the entire periphery of the welding rib 132 is heated and pressurized by a heat-welding jig 50 from a portion above the welding film 202 (see FIG. 13B). As shown in FIG. 13B, the welding rib 132 is crushed and the welding film 202 is adhered to the container body 102. At that time, the crushed welding rib 132 is deformed so as to be in a shape having the inner melted-out portion 132a, the base portion 132b and the outer melted-out portion 132c, as described above. Since it is designed so that the inner side upper face 134ui is lower than the outer side upper face 134uo by the value of ΔH, the slight gap NT is formed between the inner side upper face 134ui and the inner melted-out portion 132a.

In accordance with the above manufacturing method, the ink cartridge 100 according to the embodiment can be readily produced.

### B. Modification: First Modification

While specific shapes of the partition wall 136, the base member housing section 134, the sensor base member 210 and the sensor chip 220 are described in the above embodiment, these are examples so that it is possible to modify the components and members within the scope of the invention. For example, the partition wall 136 can be omitted and the first and second through-holes 212 and 214 can be replaced with a single through-hole. For example, the cross sectional shape of the partition wall 136 shown in FIG. 8 can be made in a tapered shape having a thin tip portion. In addition, the sensor base member 210 can be united with the sensor chip 220. Each of the first and second through-holes 212 and 214 of the sensor base member 210 can be in a polygonal column shape having a polygonal cross section such as a rectangular one.

### Second Modification

While the gap NT is formed so as to allow the thin shaped inner melted-out portion 132a to be bent and the sensor base member 210 to move in the direction away from the base member housing section 134 in the above embodiment, the welding rib 132 can be made of an elastic member instead of the above structure. It is sufficient to form the melted-outer peripheral portion of the welding film 202 so as to be elastically deformable, which makes the sensor base member 210 to be movable in accordance with the change of the ink pressure from the base member housing section 134.

### Third Modification

While in the above embodiment, a process of adhering the welding film 202 to the welding rib 132 and a process of crushing the welding rib 132 are concurrently carried out, the process of adhering can be carried out after the process of crushing of the welding rib 132.

### Fourth Modification

While in the above embodiment, the out-of-ink state is detected on the basis of the frequency of the response signal from the piezoelectric element 226, it is possible to use a sensor in a type of detecting the out-of-ink state on the basis of a magnitude of an amplitude of the response signal. In addition, it is possible to use a sensor for detecting a temperature, a resistance or any other characteristic of the ink.

### Fifth Modification

While in the above embodiment, the single ink cartridge 100 is configured to have a single ink tank, the single ink cartridge 100 can be configured to have a plurality of ink tanks.

### Sixth Modification

While in the above embodiment, the ink jet type printer 20 and the ink cartridge 100 are used, it is possible to use a liquid ejecting apparatus for ejecting a liquid other than ink and a liquid container containing the liquid. The liquid described here includes a liquid having particles of a functional material dispersed in a solvent or a fluid such as a gel material. For example, the liquid ejecting apparatus may includes a liquid ejecting apparatus that can eject a liquid including a material such as an electrode material or a colorant, dispersed or dissolved therein, the electrode material or the colorant being used for manufacturing a liquid crystal display, an EL (electro luminescence) display, a field emission display or a color filter. The liquid ejecting apparatus may further include a liquid ejecting apparatus that can eject a living organic material used for manufacturing a biochip and a liquid ejecting apparatus that can eject a liquid to be a specimen used as a fine pipet. In addition, a liquid ejecting apparatus that ejects a grease to a precision machine such as a clock or a camera in a pinpoint manner, a liquid ejecting apparatus that ejects a liquid of a transparent resin such as an ultraviolet curable resin to a substrate in order to form a fine hemispherical lens (optical lens) used for an optical communication element and a liquid ejecting apparatus that ejects an acid or alkaline etching liquid for etching a substrate can be listed. The invention can be adopted to one of the above liquid ejecting apparatuses and the liquid container for the liquid used therein.

While the embodiments and modifications according to the invention are described above, the invention is not limited thereto and can be changed or modified in various ways without departing from the spirit and scope of the invention.

What is claimed is:

1. A liquid container comprising:
a container body having a fluid channel forming portion for forming a fluid channel in which a liquid flows;
a sensor member having a sensor; and
a film that is adapted to fix the sensor member to the container body, wherein
the fluid channel forming portion has a container side opening section opened so as to face the sensor member and an outer peripheral portion disposed so as to surround the container side opening section, the film is adapted to seal a portion between an outer edge portion of the sensor member and the outer peripheral portion of the fluid channel forming portion, and the outer peripheral portion has an elastically deformable portion that allows the sensor member to move in a direction away from the container side opening section.

2. The liquid container according to claim 1, wherein
the elastically deformable portion has a thin shaped portion to which the film is adhered.

3. The liquid container according to claim 2, wherein
the thin shaped portion has a gap between the thin shaped portion and an upper wall face of the container side opening section.

4. The liquid container according to claim 3, wherein
the film is adhered to the outer peripheral portion by welding, and a height of an inner side of the outer peripheral portion is lower than a height of an outer side of the outer peripheral portion in the upper wall face of the container side opening section.

5. The liquid container according to claim 1, wherein
the sensor member is a plate member having a first face and a second face opposite the first face, the sensor member including a base member having first and second through-holes passing through the plate member from the first face to the second face and the outer edge portion surrounding the first and second through-holes, and a sensor chip that includes formed therein a cavity having a bottom and an opening section capable of receiving a liquid, and is provided with the sensor disposed at a rear side of the bottom of the cavity, the sensor chip being disposed on the first face of the base member so as to allow the opening section of the cavity to communicate with the first and second through-holes.

6. The liquid container according to claim 5, wherein
the container side opening section is a base member housing section for accommodating the second face side of the base member, and the base member housing section has a partition wall that abuts the second face of the base member and is caused by the abutment to divide the fluid channel into a first channel communicating with the first through-hole of the base member and a second channel communicating with the second through-hole of the base member.

7. The liquid container according to claim 6, wherein
the sensor is adapted to detect information about the liquid via vibration of a piezoelectric element, and the base member and the base member housing section are not in contact with each other excluding portions corresponding to a positioning portion of the base member with respect to the base member housing section and an abutment portion with respect to an end portion of the partition wall.

8. The liquid container according to claim 1, wherein
the sensor includes a piezoelectric element.

9. A method for manufacturing a liquid container by using a container body having channel forming portion for forming a fluid channel allowing a liquid to flow therein, a sensor member having a sensor, and a film for fixing the sensor member to the container body, the channel forming portion having a container side opening section opened so as to face the sensor member, a rib disposed so as to surround the opening section and an upper wall face of the container side opening section having a height at an inner side of the rib lower than that of an outer side of the rib, the method for manufacturing the liquid container comprising:
(a) fixing the film to an outer edge portion of the sensor member;
(b) positioning the sensor member to the container side opening section; and
(c) adhering the film to the rib and crushing the rib.

10. The method for manufacturing the liquid container according to claim 9, wherein
the film is welded to the rib in (c) the adhering of the film to the rib.
